(19) United States
(12) Patent Application Publication
(10) Pub. No.: US 2019/0197561 A1
(43) Pub. Date: Jun. 27, 2019

(54) IDENTIFYING PRODUCTS USING A VISUAL CODE

(71) Applicant: Trax Technology Solutions Pte Ltd, Singapore (SG)

(72) Inventors: Yair ADATO, Tel-Aviv (IL); Yotam MICHAEL, Tel-Aviv (IL); Aviv EISENSCHTAT, Tel-Aviv (IL); Ziv MHABARY, Tel-Aviv (IL); Dolev POMERANZ, Tel-Aviv (IL); Nir HEMED, Tel-Aviv (IL)

(73) Assignee: Trax Technology Solutions Pte Ltd, Singapore (SG)

(21) Appl. No.: 16/310,157

(22) PCT Filed: Jun. 28, 2017
(86) PCT No.: PCT/IB2017/000919

§ 371 Date: Dec. 14, 2018

Related U.S. Application Data
(60) Provisional application No. 62/356,000, filed on Jun. 29, 2016.

(51) Int. Cl. G06Q 30/00; G06Q 30/02; G06K 9/00; G06T 7/73; G06K 9/62; G06K 9/20; G06T 7/00

(52) U.S. Cl. CPC G06Q 30/018; G06Q 30/0238; G06Q 30/0236; G06K 9/00671; G06K 2209/25; G06K 9/6289; G06K 9/2063; G06T 7/0002; G06T 7/73

(57) ABSTRACT

This disclosure relates to systems, methods, and devices that can identify products on a shelf, and determine item descriptions and pricing from associated labels. In one embodiment, an image processing system for providing an indication about shelf label accuracy in a store is provided. The image processing system comprises at least one processor configured to receive, from a hand-held device, an image depicting products on store shelves, and associated labels coupled to the store shelves. The processor can be configured to process the image to identify at least some of the products and to access a database to determine associated product ID numbers. The processor can be further configured to determine product identifier and displayed price from the associated labels. The processor can also be configured to determine one or more product-label mismatches related to incorrect product placement on the shelf and to provide electronic notification of the mismatches.

### CROSS REFERENCES TO RELATED APPLICATIONS

This application claims the benefit of priority of U.S. Provisional Patent Application No. 62/356,000, filed on Jun. 29, 2016, which is incorporated herein by reference in its entirety.

### BACKGROUND

### I. Technical Field

The present disclosure relates generally to image processing, and more specifically to system, methods, and devices that can recognize products on shelves and item descriptions from labels based on information captured by an image sensor.

### II. Background Information

Shopping in stores is a prevalent part of modern daily life. Store owners stock a wide variety of products on store shelves and add associated labels to the store shelves. The labels can comprise various product information, for example, name, quantity, pricing, special promotions etc.

In some situations, there can be a mismatch between a product and its label. For example, an employee may stock some units of a product on the wrong shelf thereby creating a mismatch between the product and the associated label attached to the shelf. In another example, an employee may attach the wrong label to a shelf thereby creating a mismatch between the product on the shelf and the associated label. In other situations, there can be a mismatch between a product and its displayed price. As an example, a product manufacturer may instruct a store owner to offer a product at an updated sale price. But the updated labels may not be attached to all the associated shelves thereby creating a mismatch between the product and the displayed price.

These situations can have negative implications for consumers, store owners and manufacturers. For example, a consumer may make a purchase decision based on wrong information. In another example, the store or manufacturer may lose product sales due to a wrong displayed price. It is a technical challenge to regularly monitor all store shelves for the mismatches described above.

The disclosed devices and methods are directed to providing a new way for providing an indication about shelf label accuracy in a store and solves at least some of the problems outlined above.

### SUMMARY

Embodiments consistent with the present disclosure provide systems and methods for providing an indication about shelf label accuracy in a store and for monitoring compliance with contracts between retailers and suppliers.

In one embodiment, a non-transitory computer-readable medium for an image processing system may be provided. The computer-readable medium may include instructions that when executed by a processor cause the processor to perform a method for providing an indication about shelf label accuracy in a store. The method may comprise: receiving, from a hand-held device, an image depicting a plurality of products on a plurality of store shelves, and a plurality of labels coupled to the store shelves and associated with the plurality of products; processing the image to identify at least some of the plurality of products in the image based on visual characteristics of the plurality of products; accessing at least one database to determine product ID numbers associated with each of the identified products, the determination occurring through analysis of product features in the image; processing the image to determine from labels associated with each of the identified products, a specific product identifier and a specific displayed price; determining a product-label mismatch associated with a first product depicted in the image, wherein the product-label mismatch relates to an incorrect product placement on the shelf; accessing the at least one database to determine an accurate price for the identified products; determining a price mismatch associated with a second product depicted in the image, wherein the price mismatch relates to an incorrect price display; and based on the image in which the product-label mismatch and the price mismatch are identified, providing electronic notification of both the product-label mismatch and the price mismatch.

In accordance with another disclosed embodiment, an image processing system for providing an indication about shelf label accuracy in a store is provided. The image processing system may comprise at least one processor configured to: receive, from a hand-held device, an image depicting a plurality of products on a plurality of store shelves, a plurality of labels coupled to the store shelves, and at least one promotion sign associated with the plurality of products; process the image to identify at least some of the plurality of products in the image based on visual characteristics of the plurality of products; access at least one database to determine product ID numbers associated with each of the identified products, the determination occurring through analysis of product features in the image; process the image to determine from labels associated with each of the identified products, a specific product identifier and a specific displayed price; determine a product-label mismatch associated with a first product depicted in the image shelf, wherein the product-label mismatch relates to an incorrect product placement on the shelf; access the at least one database to determine an accurate promotion data for the identified products; determine a product-promotion mismatch associated with the at least one promotion sign depicted in the image, wherein the product-promotion mismatch relates to incorrect data displayed on the at least one promotion sign; based on the image in which the product-label mismatch and the product-promotion mismatch are identified, providing electronic notification of both the product-label mismatch and the product-promotion mismatch.

In accordance with another disclosed embodiment, an image processing system for providing an indication about shelf label accuracy in a store is provided. The image processing system may comprise at least one processor configured to: receive, from a hand-held device, an image depicting a plurality of products on a plurality of store shelves, and a plurality of labels coupled to the store shelves and associated with the plurality of products; process the image to identify at least some of the plurality of products in the image based on visual characteristics of the plurality of products; access at least one database to determine product ID numbers associated with each of the identified products, the determination occurring through analysis of product features in the image; process the image to determine from labels associated with each of the identified products, a specific product identifier and a specific displayed price; determine a first product-label mismatch associated with a first product depicted in the image shelf, wherein the product-label mismatch relates to a first incorrect product placement on the shelf; determine a second product label associated with a second product depicted in the image, wherein the product label mismatch relates to a second incorrect product placement on the shelf; based on the image in which the first product-label mismatch and the second product-label mismatch are identified, providing electronic notification of both the first product-label mismatch and the second product-label mismatch.

In accordance with another disclosed embodiment, a method for providing an indication about shelf label accuracy in a store is provided. The method may comprise: receiving, from a hand-held device, an image depicting a plurality of products on a plurality of store shelves, and a plurality of labels coupled to the store shelves and associated with the plurality of products; processing the image to identify at least some of the plurality of products in the image based on visual characteristics of the plurality of products; accessing at least one database to determine product ID numbers associated with each of the identified products, the determination occurring through analysis of product features in the image; processing the image to determine from labels associated with each of the identified products, a specific product identifier and a specific displayed price; determining a first price mismatch associated with a first product depicted in the image, wherein the price mismatch relates to a first incorrect price display in the image; determining a second price mismatch associated with a second product depicted in the image, wherein the price mismatch relates to a second incorrect price display in the image; and based on the image in which the first price mismatch and the second price mismatch are identified, providing electronic notification of both the first price mismatch and the second price mismatch.

In accordance with another disclosed embodiment, an image processing system for monitoring compliance with contracts between retailers and suppliers is provided. The image processing system may comprise at least one processor configured to: identify an area of interest in a retail establishment using a database of contract-related data reflecting at least one contractual obligation for placement of products on at least one shelf in the retail establishment; detect a plurality of mobile devices in proximity to or within the retail establishment; provide to each of the detected plurality of mobile devices a request for an updated image of the area of interest; receive, from the plurality of mobile devices, a plurality of images of the area of interest; select from the plurality of images at least one image of the area of interest; analyze the selected at least one image to derive image-related data; compare the image-related data with the contract-related data to determine if a disparity exists between the at least one contractual obligation and a current placement of products in the area of interest; and generate a notification if, based on the comparison, the disparity is determined to exist.

In accordance with another disclosed embodiment, a non-transitory computer-readable medium for an image processing system may be provided. The computer-readable medium may include instructions that when executed by a processor cause the processor to perform a method for monitoring compliance with contracts between retailers and suppliers. The method may comprise: identifying an area of interest in a retail establishment using a database of contract-related data reflecting at least one contractual obligation for placement of products on at least one shelf in the retail establishment; detecting a plurality of mobile devices in proximity to or within the retail establishment; providing to each of the detected plurality of mobile devices a request for an updated image of the area of interest; receiving, from the plurality of mobile devices, a plurality of images of the area of interest; selecting from the plurality of images at least one image of the area of interest; analyzing the selected at least one image to derive image-related data; comparing the image-related data with the contract-related data to determine if a disparity exists between the at least one contractual obligation and a current placement of products in the area of interest; and generating a notification if, based on the comparison, the disparity is determined to exist.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments. In the drawings:

FIG. 1 is an illustration of an exemplary system for analyzing information collected from a retail store;

FIG. 2 is a block diagram of exemplary components of systems, consistent with the present disclosure;

FIG. 3 is a schematic illustration of exemplary images, consistent with the present disclosure, depicting a plurality of products on a plurality of store shelves, and a plurality of labels coupled to the store shelves and associated with the plurality of products;

FIG. 4 is a schematic illustration of exemplary electronic notifications about shelf label accuracy, consistent with the present disclosure;

FIG. 5 is an illustration of non-numeric codes on a plurality of product labels, consistent with the present disclosure;

FIG. 6 is a flowchart of an exemplary method for providing an indication about shelf label accuracy in a store, consistent with the present disclosure;

FIG. 7 is an illustration of exemplary communications between an image processing system and a mobile device, consistent with the present disclosure;

FIG. 8 is an illustration of an exemplary usage of an image processing system for monitoring contract compliance, consistent with the present disclosure;

FIG. 9 is a flowchart of an exemplary method for monitoring compliance with contracts between retailers and suppliers, consistent with the present disclosure.

### DETAILED DESCRIPTION

Reference will now be made in detail to the exemplary embodiments implemented according to the present disclosure, the examples of which are illustrated in the accompanying drawings. Wherever possible the same reference numbers will be used throughout the drawings to refer to the same or like parts. The disclosure is not limited to the described embodiments and examples. Instead, the proper scope is defined by the appended claims.

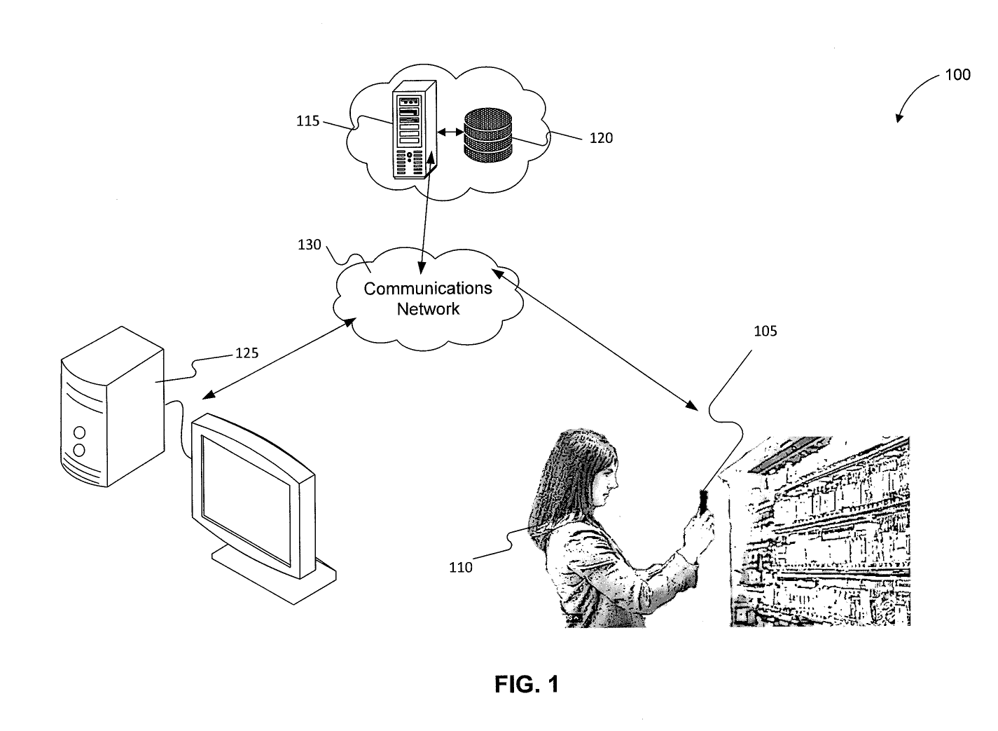

Reference is now made to FIG. 1, which shows an example of a system 100 for analyzing information collected from a retail store. In one embodiment, system 100 may represent a computer-based system that includes computer system components, desktop computers, workstations, tablets, handheld computing devices, memory devices, and/or internal network(s) connecting the components. System 100 may include or be connected to various network computing resources (e.g., servers, routers, switches, network connections, storage devices, etc.) necessary to support the services provided by system 100. In one embodiment, system 100 enables providing an indication about shelf label accuracy in a store. In another embodiment, system 100 enables providing an indication about shelf label accuracy in a store.

System 100 may include at least one capturing device 105 that may be associated with user 110, a server 115 operatively connected to a database 120, and an output unit 125 associated the retail store. The communication between the different system components may be facilitated by communications network 130.

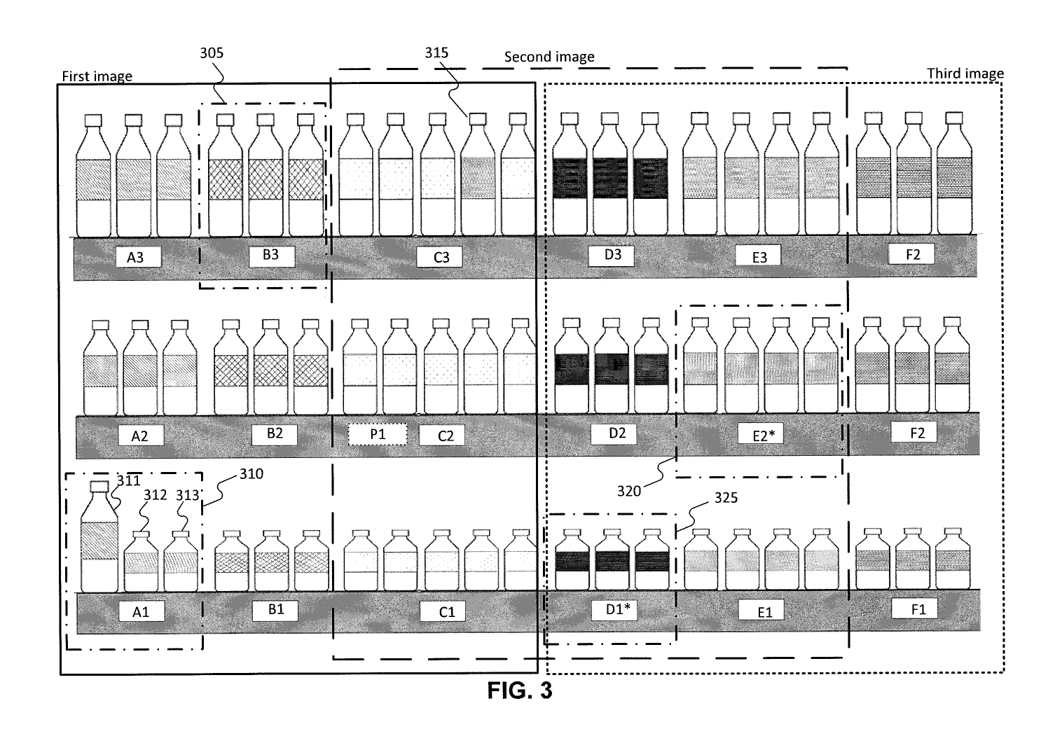

Consistent with the present disclosure, system 100 may analyze image data acquired by capturing device 105 to determine information associated with retail products. The term “capturing device” refers to any device configured to acquire image data and transmit data by wired or wireless transmission. Capturing device 105 may represent any type of device that can capture images of products on a shelf and is connectable to network 130. In one embodiment, user 110 may acquire image data of products on a shelf using capturing device 105. In this embodiment, capturing device 105 may include handheld devices (e.g., a smartphone, a tablet, a mobile station, a personal digital assistant, a laptop), wearable devices (e.g., smart glasses, a clip-on camera), etc. In another embodiment, capturing device 105 may be operated remotely or autonomously. Capturing device 105 may include a fixed security camera with communication layers, a dedicated terminal, autonomous robotic devices, drones with cameras, etc. Capturing device 105 and using it to capture images depicting a plurality of products on a plurality of store shelves, and a plurality of labels coupled to the store shelves and associated with the plurality of products, is discussed in greater detail below with reference to FIG. 3.

Consistent with the present disclosure, capturing device 105 may exchange raw or processed data with server 115 via respective communication links. Server 115 may include one or more servers connected by network 130. In one example, server 115 may be a cloud server that processes images received from a capturing device (e.g., capturing device 105) and processes the image to identify at least some of the plurality of products in the image based on visual characteristics of the plurality of products. Server 115 may also process the received images to determine from labels associated with each of the identified products, a specific product identifier and a specific displayed price. The term “cloud server” refers to a computer platform that provides services via a network, such as the Internet. In another example, server 115 may be part of a system associated with retail store that communicates with capturing device 105 using a wireless local area network (WLAN) and can provide similar functionality as a cloud server. When remote server 115 is a cloud server it may use virtual machines that may not correspond to individual hardware. Specifically, computational and/or storage capabilities may be implemented by allocating appropriate portions of desirable computation/storage power from a scalable repository, such as a data center or a distributed computing environment. Server 115 may implement the methods described herein using customized hard-wired logic, one or more Application Specific Integrated Circuits (ASICs) or Field Programmable Gate Arrays (FPGAs), firmware and/or program logic which in combination with the computer system cause server 115 to be a special-purpose machine. According to one embodiment, the methods herein are performed by server 115 in response to a processing device executing one or more sequences of one or more instructions contained in a memory device (e.g., database 120). In some embodiments, the memory device may include operating system programs that perform operating system functions when executed by the processing device. By way of example, the operating system programs may include Microsoft Windows™, Unix™, Linux™, Apple™ operating systems, personal digital assistant (PDA) type operating systems, such as Apple iOS, Google Android, Blackberry OS, or other types of operating systems.

As depicted in FIG. 1, server 115 may be coupled to one or more physical or virtual storages such as database 120. Server 115 can access database 120 to determine product ID numbers associated with each of the identified products, the determination occurring through analysis of product features in the image. Server 115 can also access database 120 to determine an accurate price for the identified products. Database 120 may be a volatile or non-volatile, magnetic, semiconductor, tape, optical, removable, non-removable, or other type of storage device or tangible or non-transitory computer-readable medium. Database 120 may also be part of server 115 or separate from server 115. When database 120 is not part of server 115, database 120 and server 115 may exchange data via a communication link. Database 120 may include one or more memory devices that store data and instructions used to perform one or more features of the disclosed embodiments. In one embodiment, database 120 may include any suitable databases, ranging from small databases hosted on a work station to large databases distributed among data centers. Database 120 may also include any combination of one or more databases controlled by memory controller devices (e.g., server(s), etc.) or software, such as document management systems, Microsoft SQL databases, SharePoint databases, Oracle™ databases, Sybase™ databases, or other relational databases.

Consistent with the present disclosure, capturing device 105 and/or server 115 may communicate with output unit 125 to present information derived from processing image data acquired by capturing device 105. For example, server 115 may determine a product-label mismatch associated with a first product depicted in the image, wherein the product-label mismatch relates to an incorrect product placement on the shelf. Server 115 may also determine a price mismatch associated with a second product depicted in the image, wherein the price mismatch relates to an incorrect price display. Server 115 may also determine a product-promotion mismatch associated with a third product depicted in the image, wherein the product-promotion mismatch relates to incorrect data depicted on a promotion sign. A promotion sign may include any type of presentation that include sales information about specific products. Server 115 can, based on the image in which the product-label mismatch, the price mismatch, or the product-promotion mismatch are identified, provide electronic notification of any of the one or more mismatches to output unit 125. In one embodiment, output unit 125 may be part of a store manager station for controlling and monitoring different aspects of a store (e.g., updated price list, product inventory, etc.). Output unit 125 may be connected to a desktop computer, a laptop computer, a PDA, etc. In another embodiment, output unit 125 may be incorporated with capturing device 105 such that the information derived from processing image data is presented on a display of capturing device 105. In this embodiment, system 100 may identify all the products in an image in real time. Thereafter, system 100 may add a layer of information on the display of capturing device 105.

Network 130 facilitates communications and data exchange between capturing device 105, server 115, and output unit 125 when these components are coupled to network 130. In one embodiment, network 130 may be any type of network that provides communications, exchanges information, and/or facilitates the exchange of information between network 130 and different elements of system 100. For example, network 130 may be the Internet, a Local Area Network, a cellular network (e.g., 2G, 2G, 4G, 5G, LTE), a public switched telephone network (PSTN), or other suitable connection(s) that enables system 100 to send and receive information between the components of system 100.

The components and arrangements shown in FIG. 1 are not intended to limit the disclosed embodiments, as the system components used to implement the disclosed processes and features can vary. For example, system 100 may include multiple servers 110, and each server 115 may host a certain type of service, e.g., a first server that can process images received from capturing device 105 to identify at least some of the plurality of products in the image and to determine from labels associated with each of the identified products, a specific product identifier and a specific displayed price, and a second server that can determine a product-label mismatch, a price mismatch, and a product-promotion mismatch associated with one or more of the identified products.

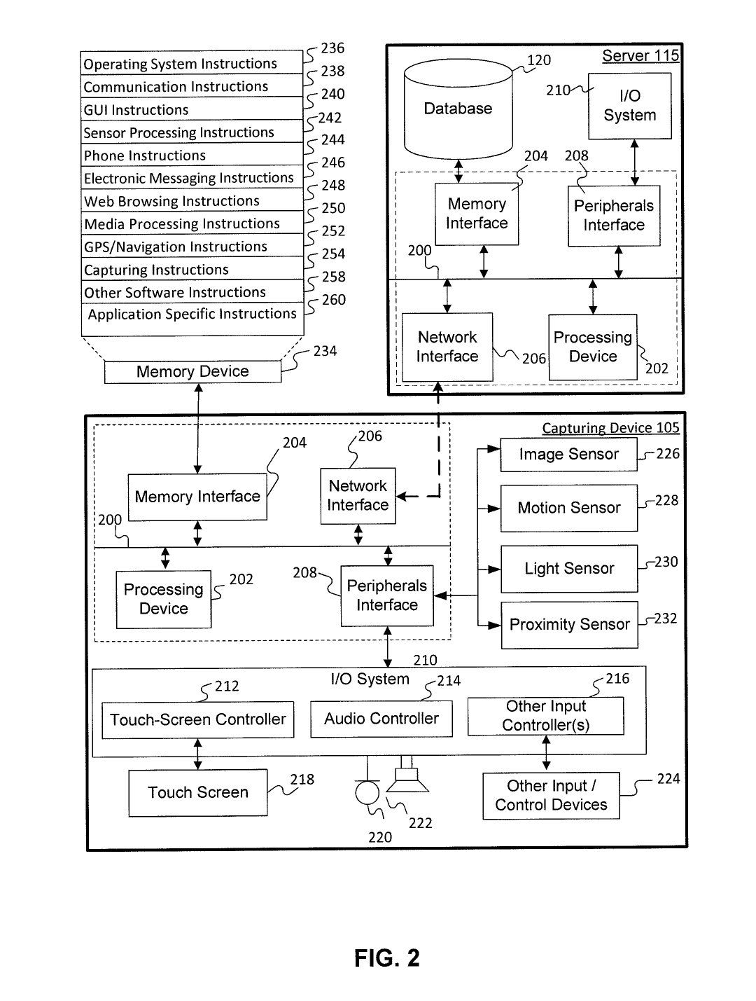

FIG. 2 is a block diagram of an example of components of capturing device 105 and server 115. In one embodiment, both capturing device 105 and server 115 includes a bus 200 (or other communication mechanism) that interconnects subsystems and components for transferring information within capturing device 105 and/or server 115. For example, bus 200 may interconnect a processing device 202, a memory interface 204, a network interface 206, and a peripherals interface 208 connected to I/O system 210.

Processing device 202, shown in FIG. 2, may include at least one processor configured to execute computer programs, applications, methods, processes, or other software to perform embodiments described in the present disclosure. The term “processing device” refers to any physical device having an electric circuit that performs a logic operation. For example, the processing device may include one or more integrated circuits, microchips, microcontrollers, microprocessors, all or part of a central processing unit (CPU), graphics processing unit (GPU), digital signal processor (DSP), field programmable gate array (FPGA), or other circuits suitable for executing instructions or performing logic operations. The processing device may include at least one processor configured to perform functions of the disclosed methods such as a microprocessor manufactured by Intel™ or manufactured by AMD™. The processing device may include a single core or multiple core processors executing parallel processes simultaneously. In one example, the processing device may be a single core processor configured with virtual processing technologies. The processing device may implement virtual machine technologies or other technologies to provide the ability to execute, control, run, manipulate, store, etc., multiple software processes, applications, programs, etc. In another example, the processing device may include a multiple-core processor arrangement (e.g., dual, quad core, etc.) configured to provide parallel processing functionalities to allow a device associated with the processing device to execute multiple processes simultaneously. It is appreciated that other types of processor arrangements could be implemented to provide the capabilities disclosed herein.

In some embodiments, processing device 202 may use memory interface 204 to access data and a software product stored on a memory device or a non-transitory computer-readable medium. For example, server 115 may use memory interface 204 to access database 120. As used herein, a non-transitory computer-readable storage medium refers to any type of physical memory on which information or data readable by at least one processor can be stored. Examples include random access memory (RAM), read-only memory (ROM), volatile memory, nonvolatile memory, hard drives, CD ROMs, DVDs, flash drives, disks, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The terms “memory” and “computer-readable storage medium” may refer to multiple structures, such as a plurality of memories or computer-readable storage mediums located within capturing device 105, server 115, or at a remote location. Additionally, one or more computer-readable storage mediums can be utilized in implementing a computer-implemented method. The term “computer-readable storage medium” should be understood to include tangible items and exclude carrier waves and transient signals.

Both capturing device 105 and server 115 may include network interface 206 coupled to bus 200. Network interface 206 may provide a two-way data communication to a local network, such as network 130. In FIG. 2 the communication between capturing device 105 and server 115 is represented by a dashed arrow. In one embodiment, network interface 206 may include an integrated services digital network (ISDN) card, cable modem, satellite modem, or a modem to provide a data communication connection to a corresponding type of telephone line. As another example, network interface 206 may include a local area network (LAN) card to provide a data communication connection to a compatible LAN. In another embodiment, network interface 206 may include an Ethernet port connected to radio frequency receivers and transmitters and/or optical (e.g., infrared) receivers and transmitters. The specific design and implementation of network interface 206 depends on the communications network(s) over which capturing device 105 and server 115 are intended to operate. For example, in some embodiments, capturing device 105 may include network interface 206 designed to operate over a GSM network, a GPRS network, an EDGE network, a Wi-Fi or WiMax network, and a Bluetooth® network. In any such implementation, network interface 206 may be configured to send and receive electrical, electromagnetic or optical signals that carry digital data streams representing various types of information.

Both capturing device 105 and server 115 may also include peripherals interface 208 coupled to bus 200. Peripherals interface 208 be connected to sensors, devices, and subsystems to facilitate multiple functionalities. In one embodiment, peripherals interface 208 may be connected to I/O system 210 configured to receive signals or input from devices and providing signals or output to one or more devices that allow data to be received and/or transmitted by capturing device 105 and server 115. In one example, I/O system 210 may include a touch screen controller 212, audio controller 214, and/or other input controller(s) 216. Touch screen controller 212 may be coupled to a touch screen 218. Touch screen 218 and touch screen controller 212 can, for example, detect contact, movement or break thereof using any of a plurality of touch sensitivity technologies, including but not limited to capacitive, resistive, infrared, and surface acoustic wave technologies as well as other proximity sensor arrays or other elements for determining one or more points of contact with the touch screen 218. Touch screen 218 can also, for example, be used to implement virtual or soft buttons and/or a keyboard. While a touch screen 218 is shown in FIG. 2, I/O system 210 may include a display screen (e.g., CRT or LCD) in place of touch screen 218. Audio controller 214 may be coupled to a microphone 220 and a speaker 222 to facilitate voice-enabled functions, such as voice recognition, voice replication, digital recording, and telephony functions. The other input controller(s) 216 may be coupled to other input/control devices 224, such as one or more buttons, rocker switches, thumb-wheel, infrared port, USB port, and/or a pointer device such as a stylus.

With regards to capturing device 105 peripherals interface 208 may also be connected to an image sensor 226 for capturing image data. The term “image sensor” refers to a device capable of detecting and converting optical signals in the near-infrared, infrared, visible, and ultraviolet spectrums into electrical signals. The electrical signals may be used to form an image or a video stream (i.e. image data) based on the detected signal. The term “image data” includes any form of data retrieved from optical signals in the near-infrared, infrared, visible, and ultraviolet spectrums. Examples of image sensors may include semiconductor charge-coupled devices (CCD), active pixel sensors in complementary metal-oxide-semiconductor (CMOS), or N-type metal-oxide-semiconductor (NMOS, Live MOS). In some cases, image sensor 226 may be part of a camera included in capturing device 105. According to some embodiments, peripherals interface 208 may also be connected to a motion sensor 228, a light sensor 230, and a proximity sensor 232 to facilitate orientation, lighting, and proximity functions. Other sensors (not shown) can also be connected to the peripherals interface 208, such as a temperature sensor, a biometric sensor, or other sensing devices to facilitate related functionalities. In addition, a GPS receiver can also be integrated with, or connected to, capturing device 105. For example, a GPS receiver can be built into mobile telephones, such as smartphone devices. GPS software allows mobile telephones to use an internal or external GPS receiver (e.g., connecting via a serial port or Bluetooth).

Consistent with the present disclosure, capturing device 105 may use memory interface 204 to access memory device 234. Memory device 234 may include high-speed random access memory and/or non-volatile memory such as one or more magnetic disk storage devices, one or more optical storage devices, and/or flash memory (e.g., NAND, NOR). Memory device 234 may store an operating system 236, such as DARWIN, RTXC, LINUX, iOS, UNIX, OS X, WINDOWS, or an embedded operating system such as VXWorkS. The operating system 236 can include instructions for handling basic system services and for performing hardware dependent tasks. In some implementations, the operating system 236 can be a kernel (e.g., UNIX kernel).

Memory device 202 may also store communication instructions 238 to facilitate communicating with one or more additional devices, one or more computers and/or one or more servers. Memory device 234 can include graphical user interface instructions 240 to facilitate graphic user interface processing; sensor processing instructions 242 to facilitate sensor-related processing and functions; phone instructions 244 to facilitate phone-related processes and functions; electronic communications devices 105 messaging instructions 246 to facilitate electronic-messaging related processes and functions; web browsing instructions 248 to facilitate web browsing-related processes and functions; media processing instructions 250 to facilitate media processing-related processes and functions; GPS/navigation instructions 252 to facilitate GPS and navigation-related processes and instructions; capturing instructions 254 to facilitate processes and functions related to image sensor 226; and/or other software instructions 260 to facilitate other processes and functions.

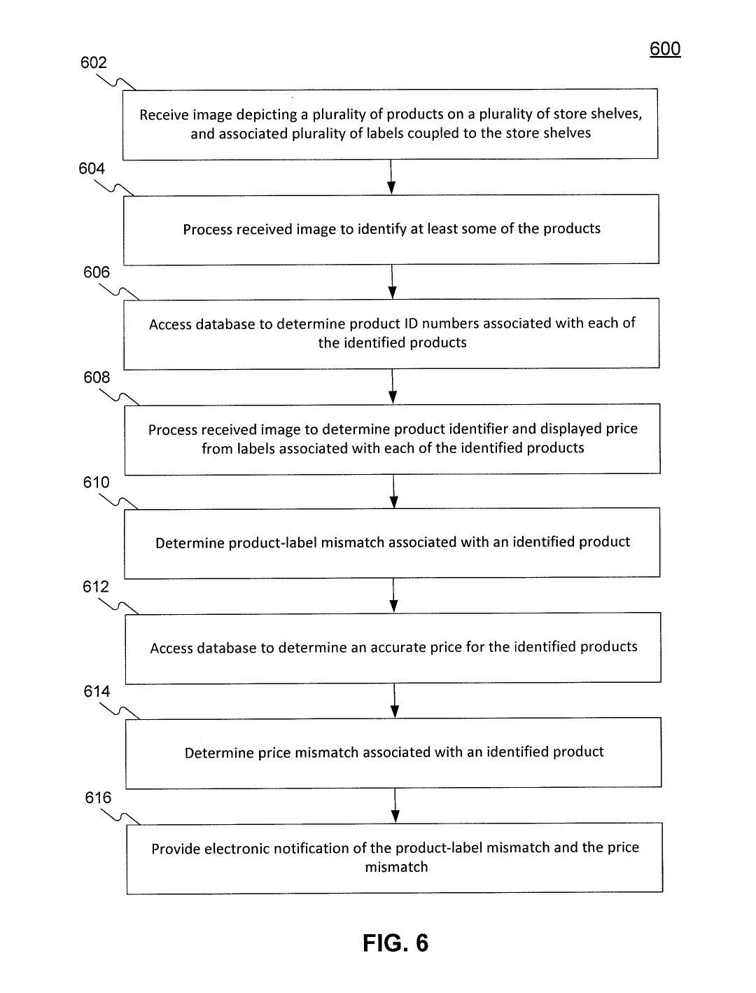

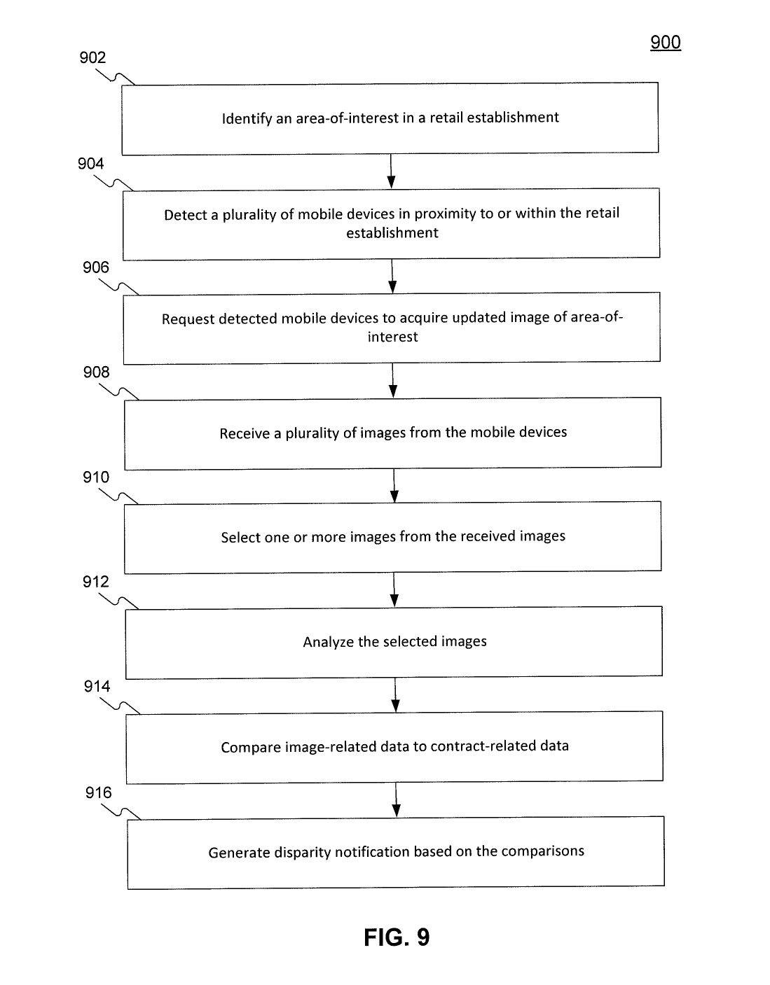

Memory device 202 may also include application specific instructions 260 to facilitate a process for providing an indication about shelf label accuracy or for monitoring compliance between retailers and suppliers. Example processes are described below with reference to FIG. 6 and FIG. 9.

In some embodiments, capturing device 105 may include software applications having instructions to facilitate connection with server 115 and/or database 120 and access or use of information about a plurality of products. Graphical user interface instructions 240 may include a software program that enables user 110 associated with capturing device 105 to acquire images of an area of interest in a retail establishment. Further, capturing device 105 may include software applications that enable receiving incentives for acquiring images of an area of interest. The process of acquiring images and receiving incentives is described in detail with reference to FIG. 9.

Each of the above identified instructions and applications may correspond to a set of instructions for performing one or more functions described above. These instructions need not be implemented as separate software programs, procedures, or modules. Memory device 234 may include additional instructions or fewer instructions. Furthermore, various functions of capturing device 105 may be implemented in hardware and/or in software, including in one or more signal processing and/or application specific integrated circuits. For example, capturing device 105 may execute an image processing algorithm to identify products in a received image.

In a first aspect of the disclosure, an image processing system (e.g., system 100) can be configured to provide one or more indications about shelf label accuracy in a store. The term “store” refers to any commercial establishment offering products for sale. In some embodiments, a store may include a retail establishment offering products for sale to consumers. A retail establishment may include shelves for display of the products and associated labels with pricing and other product information.

FIG. 3 illustrates exemplary images depicting a plurality of products on a plurality of store shelves, and a plurality of labels coupled to the store shelves and associated with the plurality of products. A capturing device (e.g., capturing device 105) may acquire the images illustrated in FIG. 3. An image processing system (e.g., system 100) may process the images and provide an indication about the shelf label accuracy.

A processing device (e.g., processing device 202 of server 115) can process the images received from the capturing device to identify at least some of the plurality of products in the images, based on visual characteristics of the plurality of the products. For example, the identification can be based on shape, size of bottles and color of fluids within the bottles depicted in FIG. 3. The products can be identified based on a confidence level of determination based on the visual characteristics. For example, in some embodiments a product is identified if it is determined to be a specific product with a confidence level greater than a threshold of 90%. In other embodiments, the threshold of confidence level for identification of products may be less than or greater than 90%.

In conventional barcode scanning, products are required to be scanned one at a time. However, the disclosed image processing systems can simultaneously identify multiple products captured in an image. The simultaneous identification of multiple products can greatly improve the speed of product identification. Further, the simultaneous identification can be used to provide contextual information for product identification, as described in greater detail below. For example, processing device 202 may identify all the products depicted in FIG. 3 except products 305 (corresponding to label B3). The threshold of confidence level for identification may be 95% and products 305 may only be determined with 85% confidence. Processing device 202 can use the determined identity of other products in the image to increase the determined confidence level of products 305 above 95% and thereby identify products 305.

Processing device 202 can further access a database (e.g., database 120) to determine product ID numbers associated with each of the identified products. The determination may occur through an analysis of products features in the image. In one example, the determination may occur based on comparison of the features of the products in the image with features of a template image stored in a database (e.g., database 120). Specifically, database 120 may store one or more template images associated with each of the known products and corresponding product ID numbers. In another example, the determination may occur through an analysis of a code placed on the product. Database 120 can be configured to store product ID numbers corresponding to the codes placed on the products. In some embodiments, database 120 may be further configured to store prices corresponding to the products and processing device 202 can further access database 120 to determine an accurate price for the identified products.

Processing device 202 may also process the images to determine a specific product identifier and a specific displayed price from labels associated with each of the identified products. For example, processing device 202 may determine a specific product identifier and a specific displayed price included in all the labels (A1, A2, A3, B1, B2, B3, C1, C2, C3, D1, D2, D3, E1, E2, E3, F1, F2, F3) depicted in FIG. 3. Processing device 202 may also process the images to determine at least one promotion sign associated with at least some of the identified products. For example, processing device 202 may identify a promotion sign P1 and determine a specific promotion associated with products associated with label C2.

The disclosed systems (e.g., system 100) can determine product-label, pricing, or product-promotion mismatches based on retrieved information of the identified products, the product information determined from the associated labels, and the data retrieved from promotion signs. In some embodiments, processing device 202 may determine a product-label mismatch associated with an identified product, wherein the product-label mismatch relates to an incorrect product placement on the shelf or absent of product placement on the shelf. For example, processing device 202 can determine a product-label mismatch based on a comparison of the determined product ID number of identified product 311 (of region 310) with the determined product ID numbers of products 312 and 313. In some embodiments, processing device 202 can determine multiple product-label mismatches simultaneously. For example, processing device 202 can determine a second product-label mismatch based on a comparison of the determined product ID number of identified product 315 with the determined product identifier included in associated label C3.

Processing device 202 can also determine a price mismatch associated with an identified product, wherein the price mismatch relates to an incorrect price display. For example, processing device 202 can determine a price mismatch based on the determined accurate price of identified products of region 320 (retrieved from database 120, as described above) and determined display price included in associated label E2. In some embodiments, processing device 202 can determine multiple price mismatches simultaneously. For example, processing device 202 can determine a second price-mismatch based on the determined accurate price of identified products of region 325 and determined display price included in associated label D1.

Processing device 202 can also determine a product-promotion associated with an identified product, wherein the product-promotion mismatch relates to incorrect data displayed on promotion sign (e.g., P1) compared to the store database. For example, processing device 202 can determine that promotion sign P1 inform costumers of a discount or a sale on products that is not updated. In some embodiments, processing device 202 can determine multiple product-promotion mismatches simultaneously. For example, processing device 202 can determine a second product-promotion mismatch based on the determined data in a second promotion sign.

In some embodiments, processing device 202 can also determine one or more product-label mismatches and one or more price mismatches simultaneously. For example, processing device 202 may simultaneously determine product-label mismatches associated with products 311 and 315, and price mismatches associated with labels E2 and D1. In some embodiments, the determination of the product-label mismatch or the price mismatch can be performed after identifying more than 50% of the plurality of products in the image based on visual characteristics of the plurality of products. In other embodiments, the determination of the product-label mismatch or the price mismatch can be performed after identifying more than 75% or 80% or 90% or 95% of the plurality of products. Further, the determination of the product-label mismatch or the price mismatch can be performed after determining the specific product identifier and the specific displayed price of more than 50% of the labels in the image. In other embodiments, the determination of the product-label mismatch or the price mismatch can be performed after identifying more than 75% or 80% or 90% or 95% of the labels in the image.

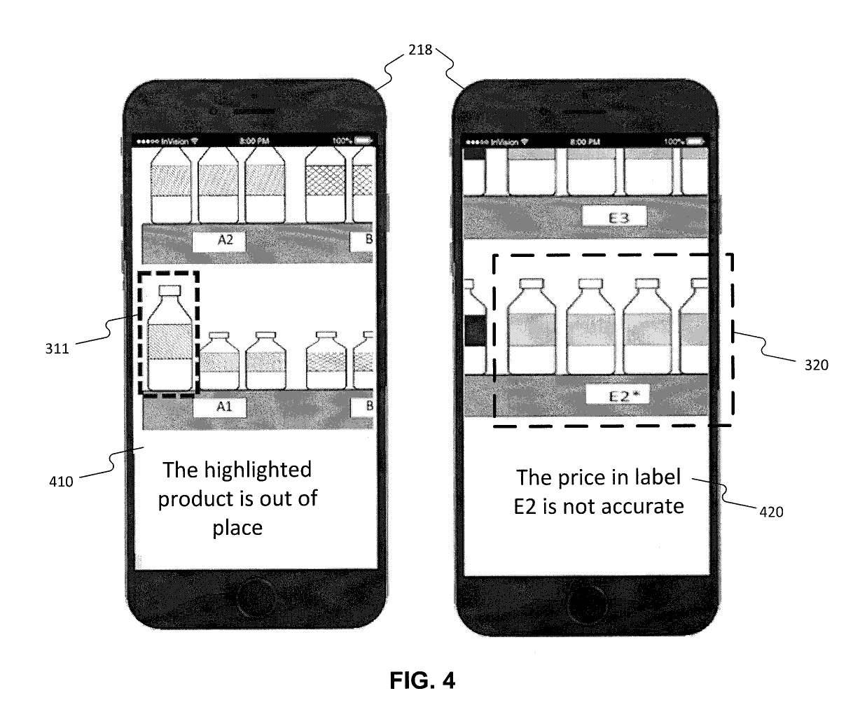

System 100 can provide an electronic notification of the product-label mismatch, the price mismatch, and the product-promotion mismatch based on the image in which the mismatches are identified. The electronic notification may be provided, for example, to touch screen 218. FIG. 4 illustrates exemplary electronic notifications about shelf label accuracy, consistent with the present disclosure. System 100 can provide an electronic notification 410 on touch screen 218 based on a product-label mismatch corresponding to product 311, determined as described above with reference to FIG. 3. Electronic notification 410 can comprise a portion of the received image with product 311 highlighted and a text notification that the highlighted product is out of place. In some embodiments, electronic notification 410 may further comprise a request to remove product 311 from the shelf. System 100 can also provide an electronic notification 420 on touch screen 218 based on a pricing mismatch corresponding to products in region 320, determined as described above with reference to FIG. 3. Electronic notification 410 can comprise a portion of the received image including region 320 and a text notification that the pricing in the associated label is not accurate. In some embodiments, electronic notification 410 may further comprise a request to print a new label with the accurate price.

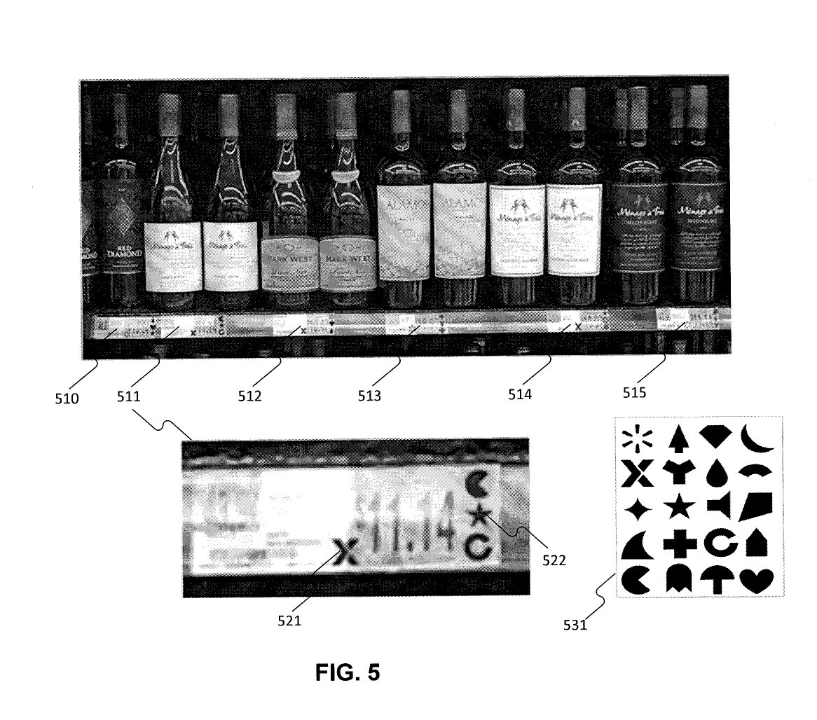

Reference is now made to FIG. 5, which is an illustration of non-numeric codes on a plurality of product labels, consistent with the present disclosure. FIG. 5 illustrates a plurality of product labels 510, 511, 512, 513, 514, and 515 associated with a plurality of products on a store shelf. Product labels can comprise information including a price, a bar code, item description, and a non-numeric code. Non-numeric codes can include a plurality of separate symbols disbursed in a non-contiguous manner. In some embodiments, each symbol has a size that is 30%-50% of the size of the displayed price on the label. One or more of the symbols can be located adjacent to a first side of the label while one or more of the symbols can be located adjacent to a second side of the label. For example, the non-numeric code on label 511 can comprise a symbol 521 located adjacent to the bottom side of label 511 and multiple symbols 522 located adjacent to the right side of label 511. In some embodiments, at least one of the symbols is spaced from another of the symbols by a distance of at least three times a dimension of one of the symbols. FIG. 5 also illustrates an exemplary set 531 of symbols that can be used on the store labels.

It is challenging for an image processing system (e.g., system 100) to determine product identifiers from a traditional code (bar code, QR code) and item description in an image of a label (e.g., label 511). In one embodiment, at least some of the plurality of labels include additional codes with spaced parallel lines at varied widths and the image is captured from a distance from the shelf in which spaces between the parallel lines are indistinguishable. Specifically, the code and item description may be too small to be identified in an image acquired from an exemplary scanning distance of 1 m, 2 m, 4 m, or more. However, system 100 can determine the product identifiers by analyzing the non-numeric code (e.g., non-numeric code on label 511 comprising 521 and 522). In some embodiments, system 100 can derive further information based on the non-numeric code, for example, price of the product, date label 511 was printed, information about neighboring products on the store shelf, information about the retail store.

In some embodiments, an image processing system (e.g. system 100) can determine the product identifier and the display price associated with a label or product based on information derived from the label associated with another product. For example, database 120 of system 100 may store placement order of products on the shelf. System 100 can determine the product identifier and the display price associated with label 512 based on its location with respect to label 511 and the information derived from label 511.

In some embodiments, an image processing system (e.g., system 100) can use contextual information available in the image to increase a confidence level in the identification of the product or the determination of displayed price. The contextual information may include identified products in the image. For example, the determined identity of a product located above the label can be used to confirm the visual code included in the label. The contextual information may further include the specific type of the identified product in the image. For example, system 100 may determine two product identifier candidates for the visual code included on label 512, one corresponding to a specific brand of red wine and the other for a specific brand of white wine. The contextual information may further include a banner or an identifier of the store. In one embodiment, system 100 may identify the store's franchise name and use this information when determining the product identity. For example, different countries, states, store chains, departments, etc., may use different sets of symbols for the non-numeric code included on labels. For example, symbols of set 531 may be used only in the produce section of stores in California. A different set of symbols can be used for other sections and states. System 100 can determine, based on the fact that all the bottles next to the label are bottles of red wine that it should be the specific brand of the red wine and not the specific brand of white wine. In some embodiments, the contextual information may include text written in promotion signs in the environment of the label, e.g. a “Sale” sign, a “New Item” sign, etc.

In some embodiments, an image processing system (e.g., system 100) can use contextual information available from a source other than the captured image to increase a confidence level in the identification of the product or the determination of displayed price. The contextual information may include a profile of a user capturing the image. For example, system 100 can process images received from a customer. System 100 can use contextual information from a profile of the customer, e.g. address, employment status, income, gender, age, education, nationality, ethnicity, marital status, credit score, personality type (as determined by past interactions), purchase history or patterns, and other relevant customer identification and biographic information. In some embodiments, the contextual information may include location of the user capturing the image. For example, system 100 can use global positioning system (GPS) coordinates received from capturing device 105 to identify the location of capturing device 105 at the time it captured the image. The location of the user may also indicate the type of the store (e.g., Target or Walmart). In some embodiments, each type of store may be associated with a different product identifier (e.g., bar code, QR code). In some embodiments, the contextual information may include section of the store where the image was captured. For example, system 100 can receive information from an indoor positioning system regarding location of capturing device 105 at the time it captured the image. The indoor positioning system may include a Wi-Fi-based positioning system (WPS), a choke point system, a grid of low-range sensors, a grid long of range sensors, or any other suitable system. Further, different times in the year may be associated may use different sets of symbols for the non-numeric code included on labels. For example, symbols of set 531 may be used only during the holidays seasons.

Reference is now made to FIG. 6, which depicts an exemplary method 600 for providing an indication about shelf label accuracy in a store. In one exemplary embodiment, all of the steps of method 600 may be performed by system 100. In the following description, reference is made to certain components of system 100 for purposes of illustration. It will be appreciated, however, that other implementations are possible and that other components may be utilized to implement the exemplary method. Specifically, method 600 discloses identifying a product-label mismatch and a price mismatch. However, a person of ordinary skill in the art would recognize that method 600 may be easily adapted to identify a product-label mismatch and a product-promotion mismatch; a price mismatch and a product-promotion mismatch; two (or more) product-label mismatches; two (or more) price mismatches; and two (or more) product-promotion mismatches. It will be readily appreciated that the illustrated method can be altered to modify the order of steps, delete steps, or further include additional steps.

At step 602, an image processing system (e.g., system 100) can receive from a capturing device (e.g., capturing device 105), an image depicting a plurality of products on a plurality of store shelves, and a plurality of labels coupled to the store shelves and associated with the plurality of products. For example, system 100 may receive from capturing device 105, the images depicted in FIG. 3.

In step 604, a processing device (e.g., processing device 202 of server 115) can process the image received from the capturing device to identify at least some of the plurality of products in the images, based on visual characteristics of the plurality of the products. For example, the identification can be based on shape, size, color, size of bottles, and color of fluids within the bottles depicted in FIG. 3. The products can be identified based on a confidence level of determination based on the visual characteristics. The processing device can simultaneously identify multiple products captured in an image. Further, the processing device can use contextual information from identified products for identification of other products in the image. For example, processing device 202 may simultaneously identify all the products depicted in FIG. 3 except products 305 (corresponding to label B3). The threshold of confidence level for identification may be 95% and products 305 may only be determined with 85% confidence. Processing device 202 can use the determined identity of other products in the image to increase the determined confidence level of products 305 above 95% and thereby identify products 305.

In step 606, the processing device can further access a database (e.g., database 120) to determine product ID numbers associated with each of the identified products. The determination may occur through an analysis of product features in the image. In one example, the determination may occur based on comparison of the features of the products in the image with features of a template image stored in the database. Specifically, the database may store one or more template images associated with each of the known products and corresponding product ID numbers. In another example, the determination may occur through an analysis of a code placed on the product. The database can be configured to store product ID numbers corresponding to the codes placed on the products. In some embodiments, the database may be further configured to store prices corresponding to the products and the processing device can further access the database to determine an accurate price for the identified products.

In step 608, the processing device can process the image to determine a specific product identifier and a specific displayed price from labels associated with each of the identified products. For example, processing device 202 may determine a specific product identifier and a specific displayed price included in labels A1, A2, A3, B1, B2, 133, C1, C2, C3, D1, D2, D3, E1, E2, E3, F1, F2, and F3. In some embodiments, the processing device can perform the determination by identifying a non-numeric code on the label. For example, process device may perform the determination by identifying symbols from set 531 (illustrated in FIG. 5). In some embodiments, the processing device can perform the determination of product identifier and displayed price by traditional image processing techniques such as optical character recognition (OCR).

In step 610, the processing device can determine a product-label mismatch associated with an identified product, wherein the product-label mismatch relates to an incorrect product placement on the shelf. For example, processing device 202 can determine a product-label mismatch based on a comparison of the determined product ID number of identified product 311 (of region 310) with the determined product ID numbers of products 312 and 313. In some embodiments, processing device 202 can determine a product-label mismatch based on a comparison of the determined product ID number of identified product 311 (of region 310) with the determined product identifier included in associated label A1. In some embodiments, the database may store information related to product placement and the processing device can determine a product-label mismatch based on the location of the identified product in the image compared with the information stored in the database. For example, database 120 may store information that product 311 should be displayed in a top left shelf location with reference to FIG. 3. Accordingly, processing device 202 can determine a product-label mismatch based on the identification of product 311 on the bottom shelf location 310.

In step 612, a processing device (e.g., processing device 202 of server 115) can access a database (e.g., database 120) to determine an accurate price for the identified products. For example, the determination may occur through an analysis of a code placed on the product. Database 120 can be configured to store prices corresponding to the products and processing device 202 can access database 120 to determine an accurate price for the identified products.

In step 614, a processing device (e.g., processing device 202 of server 115) can determine a price mismatch associated with an identified product, wherein the price mismatch relates to an incorrect price display. For example, processing device 202 can identify products of region 320 and retrieve an accurate pricing of products of region 320 from database 120. Further, processing device 202 can determine the displayed price of products of region 320 from associated label E2. Processing device can determine a price mismatch for the identified products of region 320 based on a mismatch between the retrieved accurate pricing and the determined display pricing.

In step 616, the image processing system can provide an electronic notification of both the product-label mismatch and the price mismatch based on the image in which the product-label mismatch and the price mismatch are identified. FIG. 4 illustrates exemplary electronic notifications that may be provided, for example, to touch screen 218. Electronic notification 410 can comprise a portion of the received image with product 311 highlighted and a text notification that the highlighted product is out of place. In some embodiments, the image processing system may re-process the image and repeat the identification of the products and repeat the determination of product identifiers and prices for products with a product-label or pricing mismatch. This can improve the accuracy of the mismatch notifications and reduce the occurrence of incorrect mismatch notifications. In some embodiments, electronic notification 410 may further comprise a request to remove product 311 from the shelf. System 100 can also provide an electronic notification 420 on touch screen 218 based on a pricing mismatch corresponding to products in region 320, determined as described above with reference to FIG. 3. Electronic notification 410 can comprise a portion of the received image including region 320 and a text notification that the pricing in the associated label is not accurate. In some embodiments, electronic notification 410 may further comprise a request to print a new label with the accurate price.

In a second aspect of the disclosure, an image processing system (e.g., system 100) can be configured to monitor compliance with contracts between retailers and suppliers. The contractual obligations may include placement of supplier products on at least one shelf in the retail establishment. In some embodiments, the contract-related data may include a planogram. The contract-related data can be stored in a database (e.g., database 120 of system 100). A processing device (e.g., processing device 202) can identify an area of interest in a retail establishment using the database of contract-related data. The area of interest can be any portion of the retail establishment. In some embodiments, the area of interest may include the entire store. In other embodiments, the area of interest may comprise a specific aisle in the store or a portion of the store shelves in a specific aisle of the store. The area of interest may be identified based on information stored in the database. For example, products of a specific supplier are contracted to be displayed in a specific aisle of a store and the area of interest would be the store shelves within the specific aisle. In some embodiments, the area of interest may be identified based on historical data. For example, a disparity between product placement and contractual obligations may have been previously detected and a correction notification issued to the retailer. The supplier can identify the area of interest as the store shelf where the disparity was previously detected and monitor if the disparity has been corrected. In some embodiments, the processing device may identify an area of interest based upon data received from a headoffice of the supplier.

The processing device can further detect a plurality of mobile devices in proximity to or within the retail establishment. The detection can include mobile devices of known customers of the retail establishment. The known customers may include customers having an application of the retail establishment on their mobile devices.

The processing device can be configured to provide to each of the detected plurality of mobile devices a request for an updated image of the area of interest. In some embodiments, the processing device may transmit requests based on specific location information. As an example, the processing device may first transmit requests to customer mobile devices that are determined to be within the retail establishment or in the parking lot of the retail establishment. Based on the feedback from the customers, the processing device may either not transmit additional requests or transmit further requests, e.g., to customer mobile devices detected to be within a five mile radius of the retail establishment or other distance.

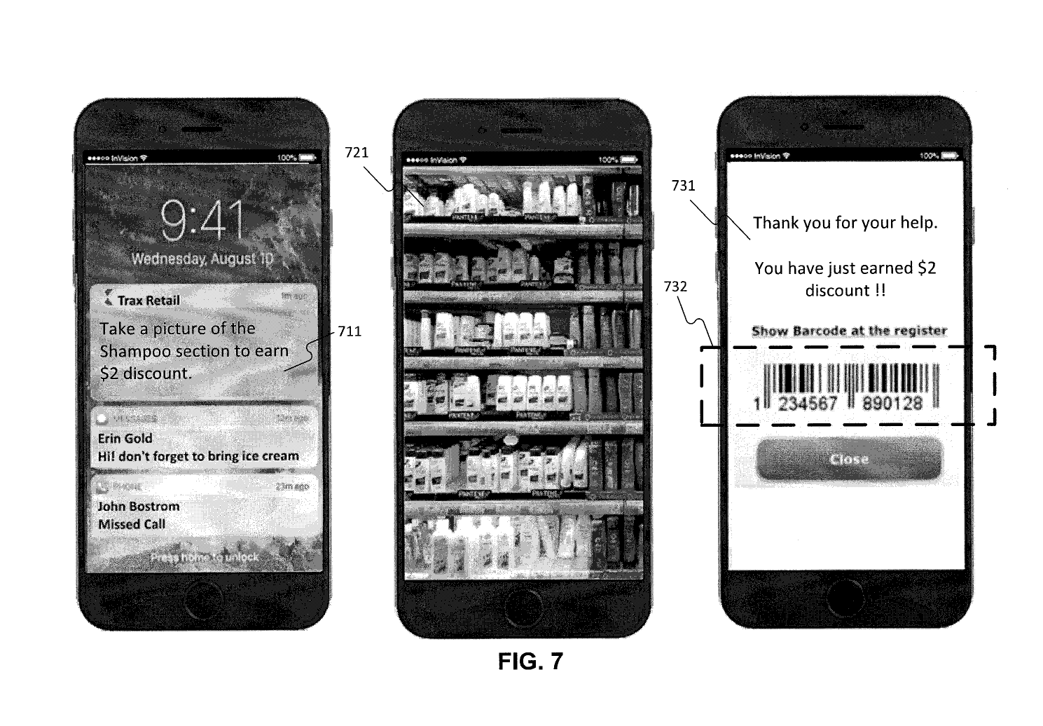

Reference is now made to FIG. 7, which illustrates exemplary communications between an image processing system and a mobile device of a user in proximity to or within the retail establishment, consistent with the present disclosure. Processing device 202 can provide a request 711 to a detected mobile device for an updated image of the area of interest. Request 711 can include an incentive (e.g., $2 discount) to the customer for acquiring the image. In response to the request, a customer can acquire an updated image 721 of an area of interest.

The processing device can be configured to receive a plurality of images (e.g., image 721) of the area of interest from a plurality of mobile devices. The received image may include video containing shelves in multiple aisles. In some embodiments, the image processing system can use an interface wherein the acquired image is automatically sent to the server (e.g., server 115) without any further user intervention. This can be used to prevent any users from editing the images and can be used as a fraud prevention mechanism. After receiving an image (e.g., image 721) from a mobile device, processing device 202 can transmit the incentive to the mobile device. The incentive can comprise a text notification and a redeemable coupon, such as, for example, a text notification 731 thanking a customer and a coupon 732 redeemable by the customer using the mobile device. In some embodiments, the incentive can include a redeemable coupon for a product associated with the area of interest.

Further, the processing device (e.g. processing device 202) can be configured to select one or all of the images of the area of interest from the plurality of received images. Processing device 202 can be configured to select a group of images that follows predetermined criteria, for example, a specific timeframe, quality of the image, distance from shelf of the capturing device, lighting during image acquisition, sharpness of the image. In some embodiments, one or more of the selected images may include a panoramic image.

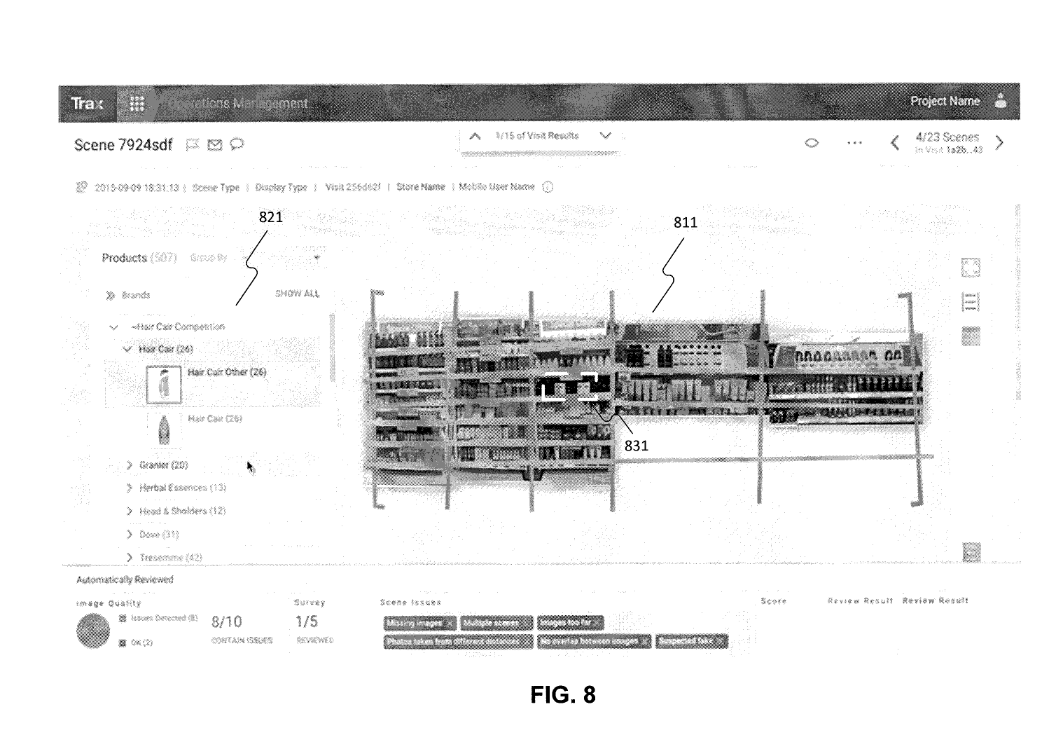

The processing device (e.g., processing device 202) can be configured to analyze the selected image(s) to derive image-related data. For cases where two or more images are selected, processing device 202 can generate image-related data based on aggregation of data from the two or more images. Reference is now made to FIG. 8, which illustrates exemplary usage of an image processing system (e.g., system 100) for monitoring contract compliance, consistent with the present disclosure. Processing device 202 may receive a plurality of images 811 depicting a plurality of differing products corresponding to areas of interest. Processing device 202 can be configured to differentiate the differing products from each other through an identification of unique identifiers in the image, for example, set 531 of symbols found in associated labels. The unique identifiers can be determined through recognizing a graphic feature or a text feature extracted from an image object representative of the at least one product. Processing device 202 may be further configured to calculate one or more analytics (e.g. key performance indicators) associated with the shelf. Processing device 202 can also be configured to determine stock keeping units (SKUs) for the plurality of differing products based on the unique identifiers (other than SKU bar codes) in the image. Processing device 202 can further determine a number of products 821 associated with each determined unique identifier. In some embodiments, processing device 202 can further be configured to calculate a shelf share for each of the plurality of products. The shelf share can be calculated by dividing an aggregated number of products associated with the one or more predetermined unique identifiers by a total number of products.

Additionally, the processing device (e.g., processing device 202) can be configured to compare the image-related data with the contract-related data to determine if a disparity exists between the contractual obligation and current placement of products in the area of interest. Processing device 202 can compare the shelf share calculated from received images (as described above) with a contracted shelf share required by an agreement between the manufacturer and a store that owns the retailer shelf. Processing device 202 can also compare display location of products in received images with a contractual obligation regarding display locations. Processing device 202 can further generate a compliance report based on the comparison.

Further, the processing device (e.g., processing device 202) can be configured to generate a notification if a disparity is determined to exist based on the comparison of the image-related data with the contract-related data. Processing device 202 can also generate a notification based on a comparison of the calculated shelf share with a contracted shelf share. The generated notification may identify products that are misplaced on the shelf. For example, the processing device can highlight shelf region 831 and indicate that the products within shelf region 831 are misplaced. The notification can also identify that a contractual obligation for shelf space by one of the plurality of products is not met.

Reference is now made to FIG. 9, which depicts an exemplary method 900 for monitoring compliance with contracts between retailers and suppliers, consistent with the present disclosure. In one embodiment, all of the steps of method 900 may be performed by system 100. In the following description, reference is made to certain components of system 100 for purposes of illustration. It will be appreciated, however, that other implementations are possible and that other components may be utilized to implement the exemplary method. It will be readily appreciated that the illustrated method can be altered to modify the order of steps, delete steps, or further include additional steps.

At step 902, a processing device (e.g., processing device 202) can identify an area of interest in a retail establishment using contract-related data in a database (e.g., database 120). The contract-related data may include product location requirements, shelf share requirements, a planogram, etc. In some embodiments, the processing device may identify an area of interest based upon data received from a head office of the supplier. The processing device can also identify an area of interest based upon time duration from a previous image being larger than a threshold time duration.

At step 904, the processing device can detect a plurality of mobile devices in proximity to or within the retail establishment. The detection can include mobile devices of known customers of the retail establishment. The known customers may include customers having an application of the retail establishment on their mobile devices.

At step 906, the processing device can provide to each of the detected plurality of mobile devices a request for an updated image of the area of interest. In some embodiments, the processing device may transmit requests based on specific location information. As an example, the processing device may first transmit requests to customer mobile devices that are determined to be within the retail establishment or in the parking lot of the retail establishment. Based on the feedback from the customers, the processing device may either not transmit additional requests or transmit further requests, e.g., to customer mobile devices detected to be within a five mile radius of the retail establishment or other distance. The transmitted request may include an incentive to the customer. For example, request 711 can include a $2 discount incentive to the customer for acquiring the image. In response to the request, a customer may acquire an updated image 721 of an area of interest. In some embodiments, the incentive can be based on the number of detected mobile devices. For example, the processing device may offer a smaller incentive if a large number of mobile devices is detected in proximity to the area of interest. The processing device may offer a larger incentive if a very small number of mobile devices is detected in proximity to the area of interest. In some embodiments, the incentive can be based on the time duration from a previous image of the area of interest. For example, the processing device may offer a larger incentive if the time duration from a previous image of the area of interest is very long. The processing device may offer a smaller incentive if the time duration from a previous image of the area of interest is short. In some embodiments, the incentive can be based on an urgency level of an image request from supplier head-office. For example, the processing device may offer a larger incentive if the image request is marked urgent. The processing device may offer a smaller incentive if the image request is marker as normal priority.

At step 908, the processing device can receive a plurality of images (e.g., image 721) of the area of interest from a plurality of mobile devices. The received image may include video containing shelves in multiple bays. After receiving an image from a mobile device, the processing device can transmit the incentive to the mobile device. The incentive can comprise a text notification and a redeemable coupon. For example, a text notification 731 thanking a customer and a coupon 732 redeemable by the customer using the mobile device.

At step 910, the processing device can select one, a group, or all of the images of the area of interest from the plurality of received images. In one embodiment, the processing device can select a group of images that follows predetermined criteria, for example, a specific timeframe, quality of the image, distance from shelf of the capturing device, lighting during image acquisition, sharpness of the image. In some embodiments, one or more of the selected images may include a panoramic image. In another embodiment, the processing device may generate a panoramic image from the selected group of images.

At step 912, the processing device can analyze the selected images to derive image-related data. For cases where two or more images are selected, the processing device can generate image-related data based on aggregation of data from the two or more images. The processing device can differentiate the differing products in the received images through an identification of unique identifiers (or code in labels). The processing device can further calculate one or more analytics (e.g., key performance indicators) associated with the shelf. The processing device can also determine SKUs for the plurality of differing products based on the unique identifiers in the image. The processing device can further calculate a shelf share for each of the plurality of products.

At step 914, the processing device can compare the image-related data with the contract-related data to determine if a disparity exists between the contractual obligation and current placement of products in the area of interest. The processing device can also compare the shelf share calculated from received images with a contracted shelf share required by an agreement between the manufacturer and a store that owns the retailer shelf. The processing device can further compare display location of products in received images with a contractual obligation regarding display locations. In some embodiments, the processing device can generate a compliance report based on the comparisons.

At step 916, a processing device (e.g., processing device 202) can generate a notification if a disparity is determined to exist based on the comparison of the image-related data with the contract-related data. Processing device 202 can also generate a notification based on a comparison of the calculated shelf share with a contracted shelf share. The generated notification may identify products that are misplaced on the shelf. The notification can also identify that a contractual obligation for shelf space by one of the plurality of products is not met.

1-40. (canceled)

41. An image processing system for monitoring compliance with contracts among retailers and suppliers, the image processing system comprising:
at least one processor configured to:
identify an area of interest in a retail establishment using a database of contract-related data reflecting at least one contractual obligation for placement of products on at least one shelf in the retail establishment;
detect a plurality of mobile devices in proximity to or within the retail establishment;
provide to at least two of the detected plurality of mobile devices a request for an updated image of the area of interest;
receive, from the at least two the plurality of mobile devices, a plurality of images of the area of interest;
analyze at least one image of the plurality of images to derive image-related data;
compare the image-related data with the contract-related data to determine if a disparity exists between the at least one contractual obligation and a current placement of products in the area of interest; and
generate a notification when, based on the comparison, the disparity is determined to exist.

42. The image processing system of claim 41, wherein the at least one image includes a panoramic image.

43. The image processing system of claim 41, wherein the at least one image includes at least two images received from different mobile devices, and wherein analyzing includes generating image-related data based on aggregated data from the at least two images.

44. The image processing system of claim 41, wherein the at least one processor is further configured to, following receipt of an image, transmit to an associated mobile device, an incentive.

45. The image processing system of claim 44, wherein the incentive includes a coupon for a product associated with the area of interest redeemable in the retail establishment by a customer using the associated mobile device.

46. The image processing system of claim 41, wherein detecting plurality of mobile devices includes identifying mobile devices of known customers of the retail establishment.

47. The image processing system of claim 46, wherein the known customers include individuals who have on their mobile devices a customer application associated with the retail establishment.

48. The image processing system of claim 41, wherein the at least one processor is further configured select the at least one image from among the plurality of images of the area of interest based on a distance from shelf of the mobile devices.

49. The image processing system of claim 41, wherein the at least one image depicts a plurality of differing products on the shelf and wherein the at least one processor is configured to differentiate the differing products from each other through an identification of unique identifiers in the image.

50. The image processing system of claim 49, wherein the at least one processor is configured to determine SKUs for the plurality of differing product based on the unique identifiers in the image, other than an SKU bar code.

51. The image processing system of claim 49, wherein at least one of the unique identifiers is determined through recognizing at least one of a graphic feature and a text feature extracted from an image object representative of the at least one product.

52. The image processing system of claim 49, wherein the at least one processor is further configured to determine a number of products associated with at least one identified unique identifier.

53. The image processing system of claim 41, wherein the at least one processor is configured to calculate a shelf share for at least one of the plurality of products.

54. The image processing system of claim 53, wherein the shelf share is calculated by dividing an aggregated number of products associated with one or more predetermined unique identifiers by a total number of products.

55. The image processing system of claim 53, wherein the at least one processor is further configured to compare the calculated shelf share with a contracted shelf share required by an agreement between a manufacturer and a store that owns the retailer shelf.

56. The image processing system of claim 41, wherein the notification identifies that a contractual obligation for shelf space is not met by at least one of the products in the area of interest.

57. The image processing system of claim 41, wherein receiving the plurality of images occurs using an interface where, when a user captures the image, the image is automatically sent to a server without further user intervention.

58. The image processing system of claim 41, wherein the at least one processor is further configured to generate a compliance report based on the comparison, the compliance report indicating whether the plurality of products are displayed at predetermined locations required by the at least one contractual obligation.

59. The image processing system of claim 41, wherein the at least one processor is further configured to calculate one or more analytics associated with the at least one shelf and wherein the analytics are key performance indicators (KPIs).

60. A non-transitory computer-readable medium including instructions that when executed by a processor cause the processor to perform a method for monitoring compliance with contracts among retailers and suppliers, the method comprising:
identifying an area of interest in a retail establishment using a database of contract-related data reflecting at least one contractual obligation for placement of products on at least one shelf in the retail establishment;
detecting a plurality of mobile devices in proximity to or within the retail establishment;
providing to at least two of the detected plurality of mobile devices a request for an updated image of the area of interest;
receiving, from the at least two of the plurality of mobile devices, a plurality of images of the area of interest;
analyzing at least one image of the plurality of images to derive image-related data;
comparing the image-related data with the contract-related data to determine if a disparity exists between the at least one contractual obligation and a current placement of products in the area of interest; and
generating a notification when, based on the comparison, the disparity is determined to exist.
